(19) United States
(12) Patent Application Publication
(10) Pub. No.: US 2024/0382918 A1
(43) Pub. Date: Nov. 21, 2024

(54) Catalyst Feeder and Processes Thereof

(71) Applicant: ExxonMobil Chemical Patents Inc., Baytown, TX (US)

(72) Inventors: Timothy J. POIRRIER, Addis, LA (US); Robert G. DEPIERRI, Baton Rouge, LA (US); Keith W. TRAPP, Kingwood, TX (US)

(21) Appl. No.: 18/689,776

(22) PCT Filed: Aug. 16, 2022
(86) PCT No.: PCT/US2022/075013

§ 371 Date: Mar. 6, 2024

Related U.S. Application Data
(60) Provisional application No. 63/261,182, filed on Sep. 14, 2021.

(51) Int. Cl. B01J 8/00; B01J 4/00; B01J 8/08; B01J 8/10; C08F 110/10

(52) U.S. Cl. CPC B01J 8/002; B01J 4/007; B01J 8/0035; B01J 8/085; B01J 8/10; C08F 110/10; B01J 2204/002; B01J 2208/00752

(57) ABSTRACT

The present disclosure provides a catalyst feeder for a polymerization process that uses a solid catalyst. A catalyst feeder includes a housing, a plug disposed radially inside the housing and rotatable relative to the housing, and an end plate coupled to the housing. If the plug is in a first rotational position, each one of a first plurality of magnets coupled, to an axial end of the plug is axially aligned with one of a. second plurality of magnets coupled to a surface of the end plate facing towards the axial end of the plug, thereby moving the plug towards a first seated position in relation to the housing. If the plug is in a second rotational position, the plurality of first magnets and the plurality of second magnets are axially offset from each other, thereby moving the plug towards an unseated position in relation to the housing.

### CROSS-REFERENCED TO RELATED APPLICATION

This application claims the benefit of U.S. Provisional Application 63/261,182 filed Sep. 14, 2021 entitled “Catalyst Feeder and Processes Thereof”, the entirety of which is incorporated by reference herein.

### FIELD

The present disclosure relates to catalyst feeders for polymerization processes that use a solid catalyst.

### BACKGROUND

Polymerization processes utilize solid catalysts to catalyze the polymerization reaction. Solid catalysts may be fed to a polymerization reactor using a catalyst feeder. A catalyst feeder is a device that provides a batch of solid catalyst (which may also be referred to as a “shot” or “drop”) to the polymerization reactor at controlled intervals. The feed rate of the solid catalyst may be measured in shots, or drops, per minute. An example catalyst feeder may have a housing and a rotatable plug disposed inside the housing. The plug may be filled with catalyst in a filling position and then rotated to a feeding position to feed the catalyst into the reactor. Another fluid may be used to flush the catalyst from the plug during feeding. The plug may be seated in the housing during filling and feeding. The plug may become unseated from the housing during rotation in order to displace or dislodge the flush fluid that is still contained within the plug so that additional catalyst may be loaded into the plug in the filling position.

A spring-loaded pin is used to reseat the plug with the housing at or near the end of plug rotation. However, both the spring and pin are susceptible to being jammed when solid catalyst enters the spring-loaded pin housing. This prevents the plug from reseating and causes failure of the catalyst feeder.

What is needed is a catalyst feeder with a reseating mechanism that is less susceptible to being jammed. There is a need for improved catalyst feeders for polymerization processes that use a solid catalyst.

Some references of particular interest in this regard include: US2012/0275931.

### SUMMARY

In some embodiments, a catalyst feeder for a solid catalyst includes a housing. The catalyst feeder includes a plug disposed radially inside the housing and rotatable relative to the housing, the plug having a first plurality of magnets coupled to an axial end of the plug. The catalyst feeder includes an end plate coupled to the housing. The end plate has a second plurality of magnets coupled to a surface of the end plate facing towards the axial end of the plug. If the plug is in a first rotational position, each one of the first plurality of magnets is axially aligned with one of the second plurality of magnets, thereby applying a first magnetic force on the plug in a first axial direction towards a first seated position in relation to the housing. If the plug is in a second rotational position, the plurality of first magnets and the plurality of second magnets are axially offset from each other, thereby applying a second magnetic force on the plug in a second axial direction towards an unseated position in relation to the housing.

In some embodiments, a catalyst feeder for a solid catalyst includes a housing. The catalyst feeder includes a plug disposed radially inside the housing and rotatable relative to the housing. The plug has a first magnet coupled to an axial end of the plug. The first magnet is radially centered on the axial end. An end plate is coupled to the housing, and the end plate has a second magnet coupled to a surface of the end plate facing towards the axial end of the plug. The second magnet is axially aligned with the first magnet, thereby applying a magnetic force continuously on the plug in a first axial direction towards a seated position in relation to the housing.

In some embodiments, a process of using a catalyst feeder for forming a polymer includes positioning a plug in a first rotational position relative to a housing of the catalyst feeder, the catalyst feeder further including an end plate coupled to the housing. The process includes, when the plug is in the first rotational position, providing a first batch of solid catalyst to a first port of the plug. The process includes rotating the plug to a further rotational position relative to the housing. The process includes, when the plug is in the further rotational position, providing a fluid to the first port of the plug to flush the first batch of solid catalyst into a reactor coupled to the housing. The process includes, when the plug is in the further rotational position, providing a second batch of solid catalyst to a second port of the plug. The second port is offset in a circumferential direction from the first port. When the plug is in each of the first and further rotational positions, one or more magnets are coupled to an axial end of the plug and are axially aligned with one or more magnets coupled to a surface of the end plate facing the axial end of the plug to apply a first magnetic force on the plug in a first axial direction towards a first seated position in relation to the housing.

### BRIEF DESCRIPTION OF THE DRAWINGS

So that the manner in which the above-recited features of the present disclosure can be understood in detail, a more particular description of the disclosure, briefly summarized above, may be had by reference to embodiments. Certain aspects of some embodiments are illustrated in the appended figures. It is to be noted, however, that the appended figures illustrate only exemplary embodiments, and therefore are not to be considered limiting of scope, and may admit to other equally effective embodiments.

FIG. 1 is a diagram illustrating a system used to perform a polymerization process, in accordance with some embodiments.

FIG. 2A is a top isometric view of an example catalyst feeder that may be used in the system of FIG. 1, in accordance with some embodiments.

FIGS. 2B, 2C, and 2D are each side cross-sectional views of the catalyst feeder of FIG. 2A, in accordance with some embodiments.

FIG. 3 is a diagram illustrating a process of using a catalyst feeder for forming a polymer, in accordance with some embodiments.

FIG. 4 is a side cross-sectional view of another example catalyst feeder that may be used in the system of FIG. 1, in accordance with some embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure relates to catalyst feeders for polymerization processes that use a solid catalyst. In at least one embodiment, catalyst feeders of the present disclosure include a housing, a plug disposed radially inside the housing and rotatable relative to the housing, and an end plate coupled to the housing. If the plug is in a first rotational position, each one of a first plurality of magnets coupled to an axial end of the plug is axially aligned with one of a second plurality of magnets coupled to a surface of the end plate facing towards the axial end of the plug, thereby moving the plug towards a first seated position in relation to the housing. If the plug is in a second rotational position (which may also be referred to as an intermediate rotational position; or as an offset rotational position), the plurality of first magnets and the plurality of second magnets are axially offset from each other, thereby moving the plug towards an unseated position in relation to the housing.

A solid catalyst of the present disclosure may be a catalyst suspended in a solvent (e.g., catalyst suspended in an aliphatic solvent) or a solid catalyst can be a catalyst system (e.g., an activated catalyst). A “catalyst system” is a combination of at least one catalyst compound, at least one activator, an optional co-activator, and an optional support material. When “catalyst system” is used to describe such a composition before activation, it means the unactivated catalyst complex (precatalyst) together with an activator and, optionally, a co-activator. When it is used to describe such a pair after activation, it means the activated complex and the activator or other charge-balancing moiety The transition metal compound may be neutral as in a precatalyst, or a charged species with a counter ion as in an activated catalyst system. For the purposes of this present disclosure and the claims thereto, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein embrace both neutral and ionic forms of the catalyst compounds and activators.

Further, a “catalyst compound” may be described as a catalyst precursor, a pre-catalyst compound, catalyst compound or a transition metal compound, and these terms are used interchangeably. A polymerization catalyst system is a catalyst system that can polymerize monomers to polymer. An “anionic ligand” is a negatively charged ligand which donates one or more pairs of electrons to a metal ion. A “neutral donor ligand” is a neutrally charged ligand which donates one or more pairs of electrons to a metal ion. Examples of neutral donor ligands include a neutral Lewis base, such as, for example, amines, alcohols, ethers, ketones, aldehydes, esters, sulfides or phosphines, which can be bonded with a metal center or can still be contained in the complex as residual solvent from the preparation of the metal complexes.

Activator and cocatalyst are also used interchangeably.

### Polymerization Process System

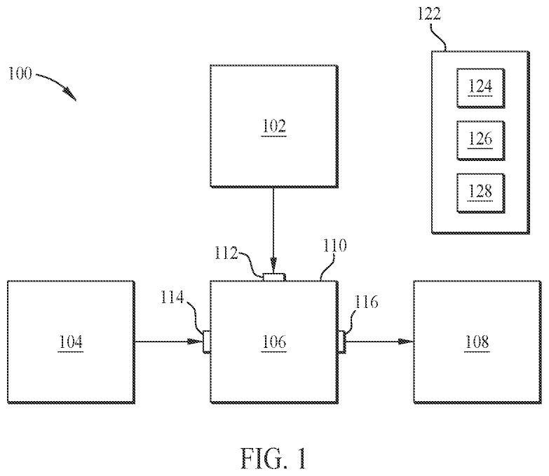

FIG. 1 is a schematic diagram conceptually illustrating a system 100 used to perform a polymerization process, in accordance with various embodiments. Referring to FIG. 1, the system 100 includes, from upstream to downstream, a catalyst reservoir 102 and a fluid source 104, a catalyst feeder 106 coupled to the catalyst reservoir 102 and to the fluid source 104, and a polymerization reactor 108 coupled to the catalyst feeder 106. The catalyst reservoir 102 and the fluid source 104 are independently coupled to the catalyst feeder 106, thereby providing two separate input branches to the catalyst feeder 106. Therefore, the catalyst reservoir 102 and the fluid source 104 may be referred to as being “in parallel.” The catalyst reservoir 102 contains a solid catalyst for feeding to the polymerization reactor 108. In some examples, the catalyst can be or include any suitable solid catalyst, such as a catalyst supported on a solid support (e.g., a silica support). Some examples of suitable catalysts are discussed below. In some embodiments, the catalyst reservoir 102 has a gas layer filling a void volume above the solid catalyst.

The fluid source 104 contains a fluid for flushing the solid catalyst from the catalyst feeder 106. In some embodiments, the fluid source 104 applies a continuous or constant fluid pressure to the catalyst feeder 106. In some embodiments, after the fluid is used to flush the solid catalyst from the catalyst feeder 106, the flush fluid migrates up and into the catalyst reservoir 102. In some examples, the flush fluid can be or include an alkane having from two to 10 carbon atoms, such as two carbon atoms (ethane), three carbon atoms (propane), four carbon atoms (e.g., butane), five carbon atoms (e.g., pentane), six carbon atoms (e.g., hexane), seven carbon atoms (e.g., heptane), eight carbon atoms (e.g., octane), nine carbon atoms (e.g., nonane), or 10 carbon atoms (e.g., decane). In some embodiments, the flush fluid is or includes isobutane, isoheptane, isohexane, other saturated hydrocarbon isomers, or combinations thereof.

As shown schematically in FIG. 1, the catalyst feeder 106 includes a housing 110 having a catalyst inlet 112 coupled to the catalyst reservoir 102, a flush inlet 114 coupled to the fluid source 104, and a catalyst outlet 116 coupled to the polymerization reactor 108. In some embodiments, the catalyst outlet 116 is rotated about 30° to about 150°, such as about 60° to about 120°, or about 30°, about 60°, about 90°, or about 120° from the catalyst inlet 112. In other words, the catalyst inlet 112 and the catalyst outlet 116 are offset about a rotational axis of the catalyst feeder 106 by about 30° to about 150°, such as about 60° to about 120°, or about 30°, about 60°, about 90°, or about 120°. In some embodiments, the flush inlet 114 and the catalyst outlet 116 are aligned on the same axis as shown. In operation, solid catalyst from the catalyst reservoir 102 is added to the catalyst feeder 106 through the catalyst inlet 112. Then, flush fluid from the fluid source 104 is added to the catalyst feeder 106 through the flush inlet 114 to push the solid catalyst out of the catalyst outlet 116 and into the polymerization reactor 108. An example of a catalyst feeder 106 is described in more detail below.

In some examples, the polymerization reactor 108 can be or include a slurry reactor, a gas phase reactor, a loop reactor, a stirred-tank reactor, or combinations thereof The term “slurry reactor” may refer to a three-phase reactor design configured to hold solids suspended in a liquid phase through which a gas is bubbled. The term “gas phase reactor” may refer to a reactor design wherein gas-phase monomers react to form a solid polymer powder. A particular example of a gas-phase reactor is a fluidized bed gas phase reactor, in which the solid polymer powder forms on solid catalyst particles, wherein the solid polymer and catalyst particles are suspended in a fluidized bed via cycle gas (comprising monomer such as ethylene, optional comonomer, as well as optional gases such as nitrogen or other inert carrier gas, inert condensing agents (ICAs), and/or other gases as known in the art of fluidized bed gas phase polymerization). In some examples, the polymerization reactor 108 may be used to form any suitable polymer, such as polyethylene, polypropylene, and copolymers thereof.

As illustrated in FIG. 1, a system (such as system 100) can further include a system controller 122 to direct the operation of one or more components of system 100. The system controller 122 as illustrated in FIG. 1 includes a programmable central processing unit (CPU) 124 which is operable with a memory 126 (e.g., non-volatile memory) and support circuits 128. The support circuits 128 are conventionally coupled to the CPU 124 and include cache, clock circuits, input/output subsystems, power supplies, and the like, and combinations thereof coupled to the various components of the system 100, to facilitate control thereof. The CPU 124 is one of any form of general purpose computer processor used in an industrial setting, such as a programmable logic controller (PLC), for controlling various components and sub-processors of the system 100. The memory 126, coupled to the CPU 124, is non-transitory and is typically one or more of readily available memories such as random access memory (RAM), read only memory (ROM), floppy disk drive, hard disk, or any other form of digital storage, local or remote.

Typically, the memory 126 is in the form of a computer-readable storage medium containing instructions (e.g., non-volatile memory), which when executed by the CPU 124, facilitates the operation of the system 100. The instructions in the memory 126 are in the form of a program product such as a program that implements the methods of the present disclosure.

The program code can conform to any one of a number of different programming languages. In one example, the disclosure may be implemented as a program product stored on computer-readable storage media for use with a computer system. The program(s) of the program product define functions of the embodiments (including the methods described herein).

Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are embodiments of the present disclosure. In some embodiments, the methods set forth herein, or portions thereof, are performed by one or more application specific integrated circuits (ASICs), field-programmable gate arrays (FPGAs), or other types of hardware implementations. In some other embodiments, the polishing pad manufacturing methods set forth herein are performed by a combination of software routines, ASIC(s), FPGAs and, or, other types of hardware implementations.

The system controller 122 is configured to control temperatures, pressures, and flow rates within and between the catalyst reservoir 102, the fluid source 104, the catalyst feeder 106, and the polymerization reactor 108. In some embodiments, the instructions used by the system controller 122 to direct the operation of the system 100 include control of temperatures, pressures, and flow rates, among other process parameters, effectuated by actuators or other suitable control devices (not shown in FIG. 1) communicatively coupled to the controller 122 so as to enable physical activation of the actuator or other control device. Such instruments for implementing control commands in a physical system are well known in the art of process controls and are not further discussed herein.

### Exemplary Catalyst Feeder

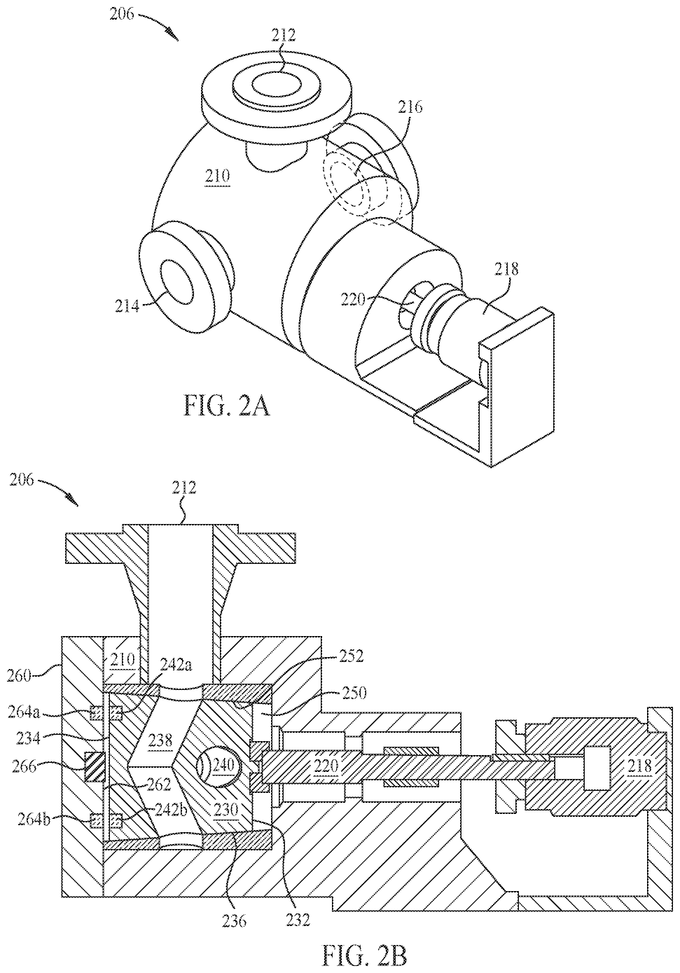

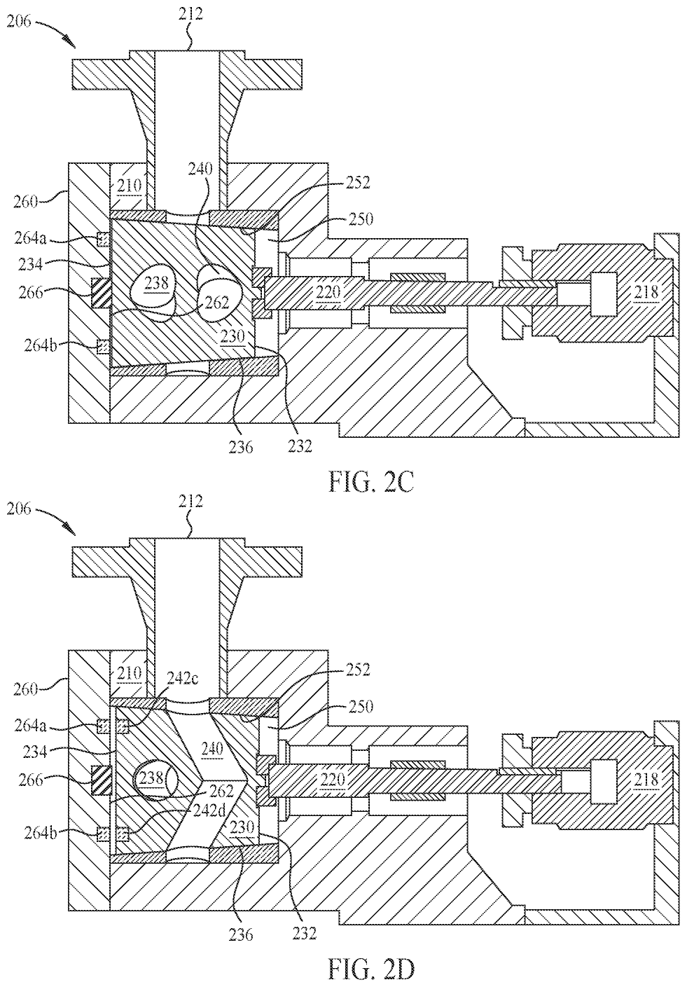

FIG. 2A is a top isometric view of an example catalyst feeder 206 that may be used in the system 100 of FIG. 1, according to some embodiments. Referring to FIG. 2A, the catalyst feeder 206 generally includes a housing 210 having a catalyst inlet 212, a flush inlet 214, and a catalyst outlet 216. In some embodiments, the housing 210 is formed from a steel alloy, such as carbon steel. An actuator 218 is coupled to the housing 210. A shaft 220 extends from the actuator 218 and into the housing 210 where the shaft 220 is coupled to a plug (shown in FIG. 2B) inside the housing 210. In some embodiments, the actuator 218 is a rotary actuator designed to rotate by a fixed angle, such as about 30° to about 150°, such as about 60° to about 120°, or about 30°, about 60°, about 90°, or about 120°. In some other embodiments, the actuator 218 is an electric motor with program stops set at uniform intervals, such as about 30° to about 150°, such as about 60° to about 120°, or about 30°, about 60°, about 90°, or about 120°. The system controller 122 controls the actuator 218. In some embodiments, the instructions used by the system controller 122 to direct the operation of the actuator 218 include rotational positions, actuation rates, and actuation frequency or timing. In operation, the shaft 220 is rotated by the actuator 218. Rotation of the shaft 220 causes the plug to rotate in relation to the housing 210 as described in more detail below.

FIGS. 2B, 2C, and 2D are side cross-sectional views of the catalyst feeder 206 of FIG. 2A, according to some embodiments. Note that the flush inlet 214 is oriented out of the page and towards the viewer, and therefore not shown, in the cross-sectional view of FIGS. 2B-2D. Also note that the catalyst outlet 216 is axially aligned with the flush inlet 214 and oriented into the page and away from the viewer in the cross-sectional view of FIGS. 2B, 2C, and 2D, and thus also not shown. Referring to FIG. 2B, the catalyst feeder 206 generally includes a plug 230, a liner 250 surrounding the plug 230, and an end plate 260 coupled to the housing 210.

The plug 230 is disposed radially inside the housing 210 and the liner 250. The plug 230 has a first axial end 232 facing in a proximal direction in relation to the housing 210. The first axial end 232 is coupled to the shaft 220. The plug 230 may be rotated by the actuator 218 (e.g., via the actuator 218 rotating the shaft 220, which in turn causes the coupled plug 230 to rotate). The plug 230 has a second axial end 234 facing in a distal direction in relation to the housing 210. The second axial end 234 faces the end plate 260. The plug 230 has an outer surface 236 connecting the first and second axial ends 232, 234. First and second ports 238, 240 are disposed through the plug 230, each in a generally transverse direction. As shown in FIGS. 2B-2D, the first and second ports 238, 240 are offset from each other in a circumferential direction by about 90° (that is, when viewed head-on in a direction along the shaft 220, and analogizing to a clock face, the first port 238 traverses 6-to-12 (vertical dissection of the clock face) and the second port 240 traverses 3-to-9 (horizontal dissection of the clock face)). However, in some embodiments, the first and second ports 238, 240 can be offset one from the other by about 30° to about 150°, such as about 60° to about 120°, or about 30°, about 60°, about 90°, or about 120°. Openings in the outer surface 236 of the plug 230 corresponding to the first port 238 are aligned on the same transverse plane; and openings on the outer surface 236 of the plug 230 corresponding to the second port 240 are aligned on the same transverse plane. Openings in the outer surface 236 of the plug 230 corresponding to the first and second ports 238, 240 are spaced in a circumferential direction to correspond to the spacing of the catalyst inlet 212, the flush inlet 214 (referring back to FIG. 2A), and the catalyst outlet 216 (also referring back to FIG. 2A) in the housing 210.

The plug 230 can be formed from a steel alloy, such as Nitralloy 135. The plug 230 also or instead can be coated with a nitride layer to resist damage that may occur due to the abrasiveness of the solid catalyst. Further, the plug 230 may optionally be nitrided to hardness Rockwell C 65.

The materials of construction of the liner 250 optionally can be the same as the plug 230. For instance, the liner 250 can be formed from a steel alloy, such as Nitralloy 135; also or instead, the liner 250 can be coated with a nitride layer to resist damage that may occur due to the abrasiveness of the solid catalyst; and/or the liner 250 can be nitrided to hardness Rockwell C 65.

The end plate 260 encloses the plug 230 and the liner 250 inside the housing 210. The end plate 260 has an axial surface 262 facing towards the second axial end 234 of the plug 230. In some embodiments, the end plate 260 is formed from a steel alloy, such as ASTM A105 carbon steel.

In some embodiments, the plug 230 and the end plate 260 are each formed at least in part from a magnetic material, such as ferrous steel. In some other embodiments, one of the plug 230 or the end plate 260 is magnetic, whereas the other one is non-magnetic. In one example, the plug 230 is formed from ferrous steel and the end plate 260 is formed from stainless steel. In some other embodiments, both the plug 230 and the end plate 260 are non-magnetic.

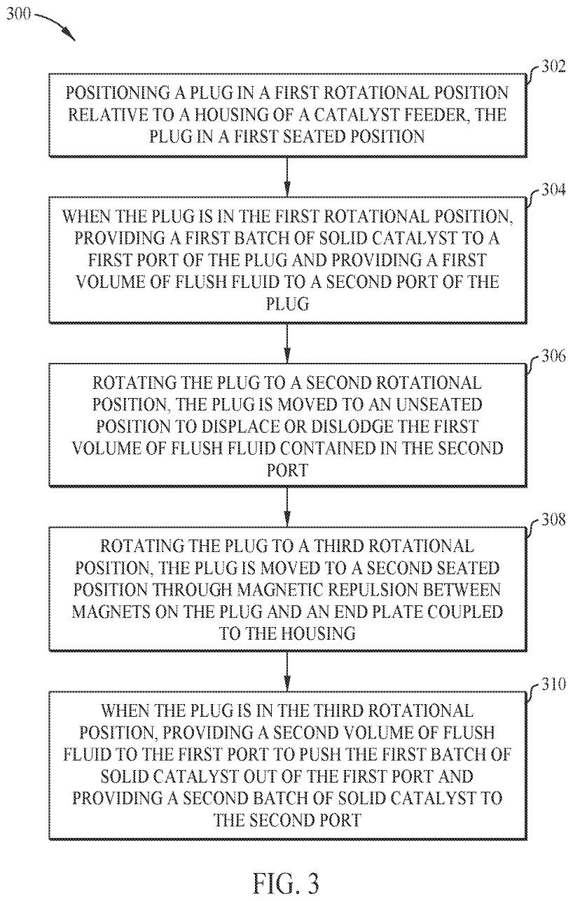

One or both of the plug 230 and the end plate 260 can have a non-magnetic body with magnetic inserts disposed in the non-magnetic body. In such embodiments, the non-magnetic body may be formed from stainless steel, and the magnetic inserts may be formed from ferrous steel. The inserts enable control of magnetic forces on the plug 230 as described below independent of the material of the body. In further discussion of the embodiment illustrated in FIGS. 2B, 2C, and 2D, it will be seen that magnetic inserts are employed—and in particular a first plurality of magnets 242 and second plurality of magnets 264. In conjunction with these magnetic inserts, either or both of the plug 230 and end plate 260 can be magnetic or non-magnetic, as discussed in context below in connection with FIGS. 2B-2D as well as in connection with methods discussed in connection with FIG. 3.

The first plurality of magnets 242 (242a, 242b, 242c, and 242d) is coupled to the second axial end 234 of the plug 230. Magnets 242a and 242b are shown in FIG. 2B (having a first rotational configuration of the plug with the pair of transverse ports 238 and 240); magnets 242c and 242d are shown in FIG. 2D (having a configuration 90° rotationally offset from the first configuration, with respect to the housing 210, referred to in connection with FIG. 2D as a third or further rotational position). The rotational configuration of the plug 230 in each of FIGS. 2B, 2c, and 2D are discussed in more detail below. Returning to the first plurality of magnets 242, these magnets 242 enable control of seating and unseating of the plug 230 as described in more detail below. In some embodiments, the plug 230 includes two to eight magnets, such as two to four magnets, such as two magnets, three magnets, or four magnets, or five to eight magnets, such as five magnets, six magnets, seven magnets, or eight magnets. The number of magnets affects the degree of rotation between different rotational positions as described in more detail below. In the illustrated embodiments, the plug 230 includes four magnets.

The first plurality of magnets 242 are inset in the second axial end 234 of the plug 230 to avoid damage to the magnets that may occur due to contact with the end plate 260. In some embodiments, adhesive (e.g., Loctite 620) can be used to couple the first plurality of magnets 242 to the plug 230. The adhesive can have a compressive shear strength greater than 2,000 pounds per square inch (psi), such as about 2,500 psi, after 24 hours when measured at 76° F., according to ISO 10123. Also or instead, the adhesive may have a bonding strength about 1,000 pound-force (lbf) to about 2,500 lbf, such as about 2,000 lbf, for each magnet. In some examples, the adhesive may retain greater than 50% bonding strength up to 250° C., according to ISO 10123.

In some embodiments, the first plurality of magnets 242 are equally spaced from each other in a circumferential direction. In the illustrated embodiments, the first plurality of magnets 242 are offset from each other by about 90° (returning to analogy to a clock face, when viewed head-on along the axis of the shaft 220, the first plurality of magnets are located at the 12 o'clock, 3 o'clock, 6 o'clock, and 9 o'clock positions). More generally, the first plurality of magnets 242 may be spaced apart from each other, independently, by about 5° to about 180°, such as about 5°, about 30°, about 45°, about 60°, about 75°, about 90°, about 105°, about 120°, about 135°, about 150°, or about 180°, or about 30° to about 150°, such as about 45° to about 135°, such as about 60° to about 120°, such as about 75° to about 105°. In some embodiments, the magnets of the first plurality of magnets are spaced apart from each other uniformly in the circumferential direction (such that, of course, the degree of circumferential separation may vary depending upon the number of magnets employed in the first plurality of magnets). In the illustrated embodiments, the first plurality of magnets 242 are equally spaced in a radial direction from a center axis of the second axial end 234 of the plug 230. In some embodiments, a radius of the first plurality of magnets 242 measured from the center axis as a fraction of a radius of the second axial end 234 is about 0.2 to about 0.9, such as about 0.5 to about 0.8, such as about 0.5, about 0.6, about 0.7, or about 0.8.

In some embodiments, the first plurality of magnets 242 are permanent magnets. The term “permanent magnet” refers to a material that produces a persistent magnetic field without the need for an external source of magnetism or electrical power. Permanent magnets may be formed from ferromagnetic materials and alloys including materials such as iron, nickel, cobalt, and/or rare-earth metals. In some embodiments, the first plurality of magnets 242 are formed from rare-earth metals, such as neodymium (e.g., neodymium iron boron (NdFeB), neodymium grade 52, etc.). In some embodiments, the first plurality of magnets 242 have a high resistance to demagnetization that may occur at high temperature, such as greater than 95% resistance to demagnetization at temperatures below about 176° F. In some other embodiments, the first plurality of magnets 242 are electromagnets. In some embodiments, an axial cross-section of each magnet of the first plurality of magnets 242 has a round shape or a square shape. In some embodiments, dimensions of the first plurality of magnets 242 are about 0.25 inches to about 0.75 inches, such as about 0.5 inches, independently, in diameter, length, width, and/or height. In some embodiments, a surface area of each magnet of the first plurality of magnets 242 is about 0.5 in² to about 1 in², such as about 0.5 in² to about 0.75 in², such as about 0.75 in² to about 1 in², such as about 0.785 in².

The liner 250 is disposed radially inside the housing 210. Axial ends of the liner 250 are open. The liner 250 has an inner surface 252 facing the outer surface 236 of the plug 230 The liner 250 has openings corresponding to each of the catalyst inlet 212, the flush inlet 214, and the catalyst outlet 216. In the description that follows, the position and sealing of the plug 230 during seating and unseating is described with respect to the liner 250. However, in some examples, the liner 250 may be omitted. Therefore, for purposes of describing the position and sealing of the plug 230 with respect to other components of the catalyst feeder 206, the housing 210 and liner 250 may be used interchangeably without further recitation.

The second plurality of magnets 264 (264a, 264b) is coupled to the axial surface 262 of the end plate 260 The second plurality of magnets 264 enables control of seating and unseating of the plug 230 as described in more detail below. Although only first and second magnets 264a-264b are illustrated in the cross-sectional view of FIGS. 2B-2D, the end plate 260 includes four magnets. The second plurality of magnets 264 are spaced apart the same as the first plurality of magnets 242. The polarity of the second plurality of magnets 264 is the same as the polarity of the first plurality of magnets 242 such that alignment between opposing magnets on the plug 230 and the end plate 260 causes the opposing magnets to be repelled. Aspects described herein in relation to the first plurality of magnets 242 may apply to the second plurality of magnets 264 without further recitation.

As shown in FIG. 2B, the plug 230 is in a first rotational position in relation to the housing 210. When the plug 230 is in the first rotational position, the first port 238 is aligned with the catalyst inlet 212, and the second port 240 is aligned with each of the flush inlet 214 and the catalyst outlet 216. In the first rotational position, the plug 230 is disposed in a first seated position in relation to the liner 250. In the first seated position, the plug 230 is positioned fully in the proximal direction in relation to the housing 210. In the first seated position, the plug 230 is spaced fully away from the end plate 260. In some embodiments, axial spacing between the second axial end 234 of the plug 230 and the axial surface 262 of the end plate 260 is about 90 mil (2.286 mm) to about 100 mil (2.54 mm) in the first seated position. In the first seated position, the outer surface 236 of the plug 230 contacts the inner surface 252 of the liner 250. In the first seated position, the plug 230 is sealed with the liner 250 through the contacting surfaces.

When the plug 230 is in the first rotational position, each magnet of the first plurality of magnets 242 of the plug 230 is axially aligned with a corresponding magnet of the second plurality of magnets 264 of the end plate 260. As shown in FIG. 2B, the pair of first magnets 242a, 264a are aligned, and the pair of second magnets 242b, 264b are aligned When the magnets of the first and second plurality of magnets 242, 264 are aligned, a first magnetic force is applied on the plug 230 in a first axial direction towards the first seated position in relation to the liner 250. That is, since the magnets 242 and 264 are of the same polarity, they repel each other (the first magnetic force is a repulsive magnetic force), maintaining the plug 230 axially spaced from the end plate 260, as shown in FIG. 2B. In some embodiments, based on example separation distances described herein, the first magnetic force is greater than about 5 lb per magnet pair, such as about 5 lb to about 20 lb, or greater than about 10 lb, such as about 10 lb to about 20 lb, or greater than about 15 lb, such as about 15 lb to about 20 lb, such as about 16 lb per magnet pair.

As shown in FIG. 2C, the plug 230 is in a second rotational position (which may be referred to as an intermediate rotational position or an offset rotational position) in relation to the housing 210. The second rotational position is between the first rotational position (shown in FIG. 2B) and a third rotational position (shown in FIG. 2D). Between the first rotational position to the second rotational position, the plug 230 is rotated by about 15° to about 75°, such as about 30° to about 60°, such as about 30°, about 45°, or about 60°. For example, as shown in FIG. 2C, the plug 230 is rotated 45° from the first rotational position. When the plug 230 is in the second rotational position, the first and second ports 238, 240 are not aligned with the catalyst inlet 212, the flush inlet 214, or the catalyst outlet 216. In the second rotational position, the plug 230 is disposed in an unseated position in relation to the housing 210. In the unseated position, the plug 230 is positioned fully in the distal direction in relation to the housing 210. In the unseated position, the plug 230 is positioned fully towards the end plate 260 such that the second axial end 234 of the plug 230 is in contact with a bumper 266 extending from the axial surface 262 of the end plate 260 in the proximal direction in relation to the housing 210. The bumper 266 prevents the second axial end 234 of the plug 230 from directly contacting the axial surface 262 of the end plate 260 to prevent stiction therebetween. In some embodiments, axial spacing between the second axial end 234 of the plug 230 and the axial surface 262 of the end plate 260 is less than about 10 mil (0.254 mm) in the unseated position. In the unseated position, the plug 230 is no longer sealed with the liner 250.

When the plug 230 is in the second rotational position, the plurality of first magnets 242 and the plurality of second magnets 264 are axially offset from each other. When the magnets 25 of the first and second plurality of magnets 242. 264 are not aligned, a second magnetic force is applied on the plug 230 in a second axial direction towards the unseated position in relation to the liner 250. The second magnetic force is an attractive force between the first plurality of magnets 242 and the end plate 260 and/or the second plurality of magnets 264 and the plug 230. In some embodiments, based on example separation distances described herein, the second magnetic force is greater than about 5 lb per magnet, such as about 5 lb to about 20 lb, or greater than about 10 lb, such as about 10 lb to about 20 lb, or greater than about 15 lb, such as about 15 lb to about 20 lb, such as about 18 lb per magnet. When the plug 230 and the end plate 260 are both non-magnetic, the magnetic flux resulting from the first and second plurality of magnets 242, 264 applies zero magnetic force on the plug 230.

As shown in FIG. 2D, the plug 230 is in a third rotational position (which may also be referred to as a further rotational position) in relation to the housing 210. In embodiments in accordance with FIGS. 2A-2D, in the third rotational position shown in FIG. 2D, the plug 230 is rotated 90° from the first rotational position (shown in FIG. 2B). When the plug 230 is in the third rotational position, the first port 238 is aligned with each of the flush inlet 214 and the catalyst outlet 216, and the second port 240 is aligned with the catalyst inlet 212. In the third rotational position, the plug 230 is disposed in a second seated position in relation to the housing 210. In the second seated position, the plug 230 is positioned fully in the proximal direction in relation to the housing 210. In the second seated position, the plug 230 is spaced fully away from the end plate 260. In the second seated position, the outer surface 236 of the plug 230 contacts the inner surface 252 of the liner 250. In the second seated position, the plug 230 is sealed with the liner 250 through the contacting surfaces.

When the plug 230 is in the third rotational position, each magnet of the first plurality of magnets 242 of the plug 230 is axially aligned with a corresponding magnet of the second plurality of magnets 264 of the end plate 260. As shown in FIG. 2D, the third and fourth magnets 242c and 242d of the plug 230 are aligned with the first and second magnets 264a and 264b, respectively, of the end plate 260. When the magnets of the first and second plurality of magnets 242, 264 are aligned, or realigned in this case, the first magnetic force is again applied on the plug 230 in the first axial direction towards the second seated position in relation to the liner 250.

Axial movement of the plug between the seated and unseated positions as described above can be controlled based on one or more properties of the first and second plurality of magnets 242, 264 such as magnetic strength, spacing, cross-sectional shape, cross-sectional area, or combinations thereof. Improved magnetic control of axial movement of the plug 230 can enable a reduction in the continuous or constant fluid pressure applied by the fluid source 104. This improved magnetic control of axial movement of the plug 230 can also enable catalyst to be fed from the catalyst feeder 206 at or near a continuous rate. The term “continuous” may refer to a system that operates without interruption or cessation.

### Exemplary Method of Use

FIG. 3 is a diagram illustrating a process 300 of using a catalyst feeder for forming a polymer, according to some embodiments. The process 300 is described below using the catalyst feeder 206 of FIGS. 2A-2D for illustrative purposes only. The process 300 may be implemented using any suitable catalyst feeder.

At operation 302, the plug 230 is positioned in the first rotational position (shown in FIG. 2B). In the first rotational position, the plug 230 is in the first seated position as described above.

At operation 304, when the plug 230 is in the first rotational position, a first batch of solid catalyst is provided to the first port 238 of the plug 230. In addition, in the first rotational position, a first volume of flush fluid is provided to the second port 240 of the plug 230.

At operation 306, the plug 230 is rotated to a second rotational position (shown in FIG. 2C). During rotation to the second rotational position, the plug 230 is moved towards the unseated position. In some examples, the plug 230 may move an axial distance of about 80 mil (0.080 inches, or 2.032 mm) to about 100 mil (0.100 inches, or 2.54 mm) between the seated and unseated positions. Unseating of the plug 230 during rotation is able to displace or dislodge the first volume of flush fluid contained in the second port 240. Movement of the plug 230 to the unseated position may be caused by magnetic attraction between the first plurality of magnets 242 and the end plate 260, magnetic attraction between the second plurality of magnets 264 and the plug 230, and/or excess pressure applied by the flush fluid between the contacting surfaces of the plug 230 and the liner 250. When the plug 230 and the end plate 260 are both non-magnetic, the first and second plurality of magnets 242, 264 are unable to induce the magnetic attraction forces and movement of the plug 230 to the unseated position is caused by excess pressure alone.

At operation 308, the plug 230 is rotated to the third rotational position (shown in FIG. 2D). During or after rotation to the third rotational position, the plug 230 is moved towards the second seated position. Movement of the plug 230 to the second seated position is caused by alignment of, and the resulting magnetic repulsion between, the first and second plurality of magnets 242, 264.

At operation 310, when the plug 230 is in the third rotational position as shown in FIG. 2D, a second volume of flush fluid is provided to the first port 238 to push the first batch of solid catalyst out of the first port 238 (delivered at operation 304, that is, when the plug 230 was in the first rotational position as shown in FIG. 2B). In some embodiments, the first batch of solid catalyst is fed directly to a polymerization reactor coupled to the housing 210. When the plug 230 is in the third rotational position, a second batch of solid catalyst is provided to the second port 240. Then, as the plug 230 rotates back to the first rotational position, a third volume of flush fluid is provided to the second port 240, thereby pushing the second batch of solid catalyst out of the second port 240. The process can repeat continuously through ongoing rotation of the plug 230.

For instance, the process 300 can be repeated to feed a batch of catalyst through the catalyst feeder 206 at preset rotational positions of the plug 230. In certain embodiments, the rotational positions are set at about 30° to about 150°, such as about 60° to about 120°, or about 30°, about 60°, about 90°, or about 120°. The term “batch” refers to a volume of solid catalyst that fills the first port 238 at operation 304 when the plug 230 is in the first rotational position, and is subsequently removed from the first port 238 (e.g., via flush fluid provided when the plug 230 is in the third rotational position, at operation 310); and/or the term “batch” can refer to the volume of solid catalyst that fills the second port 240, e.g., at operation 308, and is subsequently removed from the second port 240, e.g., via flush fluid provided to the second port 240 upon return of the plug 230 to the first rotational position. In some embodiments, the process 300 is used to feed two to six batches of catalyst per minute, such as two, three, four, five, or six batches per minute.

### Alternative Catalyst Feeder

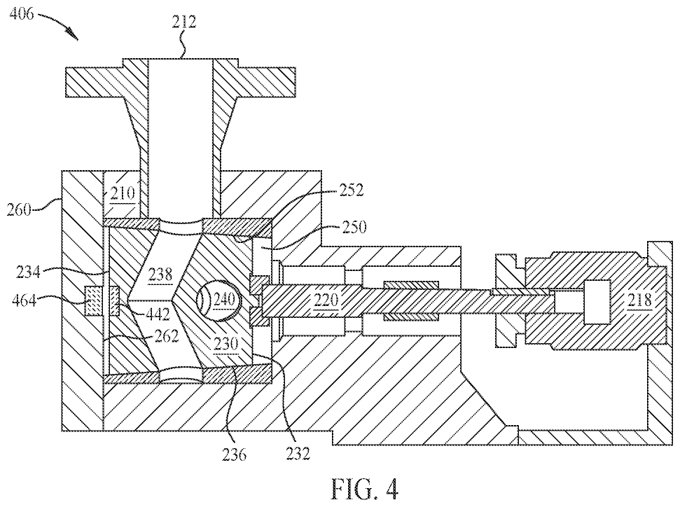

FIG. 4 is a side cross-sectional view of another example catalyst feeder 406 that may be used in the system 100 of FIG. 1, according to some embodiments. Aspects of the catalyst feeder 406 that are not specifically described below are the same as corresponding aspects of the catalyst feeder 206.

As shown in FIG. 4, the plug 230 and the end plate 260 each have only a single magnet, in contrast the first and second plurality of magnets shown in FIGS. 2B-2D. A first magnet 442 is coupled to the second axial end 234 of the plug 230. The first magnet 442 is radially centered on the second axial end 234. A second magnet 464 is coupled to the axial surface 262 of the end plate 260. The second magnet 464 is radially centered on the axial surface 262. Because each of the first and second magnets 442, 464 are radially centered, axial alignment between the first and second magnets 442, 464 is maintained continuously throughout rotation of the plug 230. The polarity of the second magnet 464 is the same as the polarity of the first magnet 442 such that the first and second magnets 442, 464 are repelled from each other. The result is a magnetic force being applied continuously on the plug 230 in the first axial direction towards a seated position in relation to the liner 250. In some embodiments, such as when using permanent magnets that are in axial alignment, the magnetic force has a constant value.

Because the magnetic repulsion force is applied continuously to the plug 230, movement of the plug 230 to the unseated position occurs only when pressure applied to the plug 230 by the flush fluid in the second axial direction exceeds the level of the magnetic repulsion force in the first axial direction. In operation, a first pressure less than the magnetic repulsion force is applied to the plug 230 by the flush fluid in each of the first and third rotational positions. A second pressure greater than the first pressure is applied to the plug 230 by the flush fluid during rotation (e.g., in the second rotational position between the first and third rotational positions). The first and second pressures are applied to the plug 230 over the same cross-sectional area. The magnetic strength and spacing of the first and second magnets 442, 464 are selected such that the force exerted by the second pressure exceeds the level of the magnetic repulsion force, thereby moving the plug 230 to the unseated position, whereas the force exerted by the first pressure is inadequate to unseat the plug 230. Therefore, the first and second magnets 442, 464 are configured to provide a force to reseat the plug 230 in relation to the liner 250 in each of the first and third rotational positions as described above.

It will be appreciated that also or instead, any magnet described herein could be an electromagnet, e.g., such that current can be selectively applied to either or all such magnets in order to selectively activate a magnetic field at such magnet(s). In this way, the electromagnet(s) could be activated to cause a repulsive magnetic force when desired to move the plug 230 into the seated position (e.g., by causing repulsive force between magnets 442 and 464 in the feeder 406; and/or between first plurality of magnets 242 and second plurality of magnets 264 in the feeder 206), and/or selectively activated to cause an attractive magnetic force between such magnet pairs, causing the plug 230 to move into the unseated position.

### Catalyst Compounds

A feeder in accordance with any embodiment described herein is suitable for feeding a variety of polymerization catalysts suitable for use in a slurry reactor, a gas phase reactor, a loop reactor, a stirred-tank reactor, or combinations thereof. Such catalysts include, without limitation, a catalyst compound having a metal atom, such as a Group 3 through Group 12 transition metal (e.g., Ziegler-Natta catalysts and/or metallocene catalysts, chromium catalysts, and the like). Chromium or Chromium-based catalysts are a particular example (e.g., for use in connection with slurry and/or gas phase fluidized bed polymerization processes). Chromium-based catalysts include chromium oxide (CrO₃) and silylchromate catalysts. Such catalysts and polymerization processes have been described, for example, in U.S. Patent Application Publication No. 2011/0010938 and U.S. Pat. Nos. 7,915,357, 8,129,484, 7,202,313, 6,833,417, 6,841,630, 6,989,344, 7,504,463, 7,563,851, 8,420,754, and 8,101,691.

Metallocene catalyst compounds as used herein include bridged and unbridged metallocene compounds with ligands such as substituted or unsubstituted cyclopentadienyl moieties (including those substituted with ring structures such that the ligand has multiple rings as in the case of indenyl and/or fluorenyl moieties). The literature is replete with examples of metallocene catalysts for polymerization, including, e.g., U.S. Pat. Nos. 5,516,848 and 8,088,867; as well as WO2016/171810; and see generally the patents and publications collected in Paragraph [0020] of US2019/0040168.

Other suitable catalyst compounds include iron complexes, such as those also described in US2019/0040168, e.g., per Paragraph [0023] thereof.

Further, combinations of any of the foregoing, and/or multiples of the same class of catalyst (e.g., multiple metallocene catalysts) can be used in connection with feeders in accordance with the present description. The catalysts can be supported or unsupported (e.g., as described in the various references already mentioned, and in particular regarding supports as described in Paragraphs [0080] to [0095] of US2019/0040168); and optionally can include activators and/or co-catalysts (e.g., alkylalumoxanes) as is also known in the art of polymerization. In this regard, see, for example, U.S. Pat. Nos. 5,041,584; 9,340,630; 8,404,880; 8,975,209; 5,942,459; 8,658,556; 6,211,105; 5,153,157; 5,453,410; as well as WO 98/43983; EP 0 573 120 B1; WO 94/07928; and WO 95/14044.

### Polymerization Processes

The present disclosure relates to polymerization processes where monomer (such as ethylene), and optionally comonomer, are contacted with a catalyst system comprising an activator and at least one catalyst compound, as described above. The catalyst compound and activator may be combined in any order, and are combined prior to contacting with the monomer.

Monomers include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof.

Exemplary C₂ to C₄₀ olefin monomers and optional comonomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene. Particular embodiments include polymerization of ethylene with one or more of the other comonomers listed above, such as a C₂ to C₁₂ a-olefin comonomer (e.g., one or more of 1-butene, 1-hexene, and 1-octene).

As also noted previously, polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be used. As used herein, the term “slurry polymerization process” means a polymerization process where a supported catalyst is employed and monomers are polymerized on the supported catalyst particles in a diluent/solvent. At least 95 wt % of polymer products derived from the supported catalyst are in granular form as solid particles (not dissolved in the diluent).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, such as less than 0 wt % based upon the weight of the solvents.

### Polyolefin Products

The present disclosure also relates to polyolefin compositions, such as resins, produced by the catalyst systems of the present disclosure. Polyolefins of the present disclosure can have no detectable aromatic solvent.

In at least one embodiment, a process includes utilizing a catalyst system of the present disclosure to produce propylene homopolymers or propylene copolymers, such as propylene-ethylene and/or propylene-alphaolefin (such as C₃ to C₂₀) copolymers (such as propylene-hexene copolymers or propylene-octene copolymers) having an Mw/Mn of greater than about 1, such as greater than about 2, such as greater than about 3, such as greater than about 4.

In at least one embodiment, a process includes utilizing a catalyst system of the present disclosure to produce olefin polymers, such as polyethylene and polypropylene homopolymers and copolymers. In at least one embodiment, the polymers produced herein are homopolymers of ethylene or copolymers of ethylene, for example, having from about 0 and 25 mole % of one or more C₃ to C₂₀ olefin comonomer (such as from about 0.5 and 20 mole %, such as from about 1 to about 15 mole %, such as from about 3 to about 10 mole %). Olefin comonomers may be C₃ to C₁₂ alpha-olefins, such as one or more of propylene, butene, hexene, octene, decene, or dodecene, such as propylene, butene, hexene, or octene. Olefin monomers may be one or more of ethylene or C₄ to C₁₂ alpha-olefin, such as ethylene, butene, hexene, octene, decene, or dodecene, such as ethylene, butene, hexene, or octene.

Overall, the present disclosure provides catalyst feeders that have a reseating mechanism that is less susceptible to being jammed and that provides improved magnetic control of plug axial movement, as compared to conventional catalyst feeders.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A catalyst feeder for a solid catalyst, the catalyst feeder comprising:
a housing;
a plug disposed radially inside the housing and rotatable relative to the housing, the plug having a first plurality of magnets coupled to an axial end of the plug; and
an end plate coupled to the housing, the end plate having a second plurality of magnets coupled to a surface of the end plate facing towards the axial end of the plug, wherein the catalyst feeder is configured to:
provide the plug in a first rotational position, wherein each one of the first plurality of magnets is axially aligned with one of the second plurality of magnets in the first rotational position, thereby applying a first magnetic force on the plug in a first axial direction towards a first seated position in relation to the housing, and
provide the plug in a second rotational position, wherein the plurality of first magnets and the plurality of second magnets are axially offset from each other in the second rotational position, thereby applying a second magnetic force on the plug in a second axial direction towards an unseated position in relation to the housing.

2. The catalyst feeder of claim 1, wherein:
the housing comprises a catalyst inlet, a flush inlet, and a catalyst outlet,
the plug comprises first and second ports offset from each other in a circumferential direction,
when the plug is in the first rotational position, the first port is aligned with the catalyst inlet, and the second port is aligned with each of the flush inlet and the catalyst outlet,
when the plug is in a third rotational position, the plug is in a second seated position in relation to the housing, the first port is aligned with each of the flush inlet and the catalyst outlet, and the second port is aligned with the catalyst inlet, and
the second rotational position is between the first and third rotational positions.

3. The catalyst feeder of claim 2, further comprising a liner disposed radially inside the housing, the liner comprising openings corresponding to each of the catalyst inlet, the flush inlet, and the catalyst outlet.

4. The catalyst feeder of claim 1, wherein the magnets of the first plurality of magnets and the second plurality of magnets comprise neodymium.

5. The catalyst feeder of claim 1, wherein each of the first plurality of magnets is inset in the axial end of the plug, and wherein each of the second plurality of magnets is inset in the surface of the end plate facing towards the axial end of the plug.

6. The catalyst feeder of claim 1, wherein the plug and the end plate each comprise ferrous steel.

7. The catalyst feeder of claim 1, wherein one or both of the plug and the end plate comprises a stainless steel body having ferrous steel inserts disposed therein, the ferrous steel inserts configured to control the second magnetic force on the plug.

8. The catalyst feeder of claim 1, wherein the magnets of the first plurality of magnets and the second plurality of magnets are spaced apart by 75° to 105°.

9. The catalyst feeder of claim 1, wherein the first magnetic force is repulsive and the second magnetic force is attractive.

10. The catalyst feeder of claim 1, wherein an axial cross-section of each magnet comprises at least one of a round shape or a square shape.

11. The catalyst feeder of claim 1, wherein the first plurality of magnets and the second plurality of magnets each comprise two to eight magnets.

12. The catalyst feeder of claim 11, wherein the first plurality of magnets and the second plurality of magnets each comprise four magnets.

13. The catalyst feeder of claim 1, wherein the magnets of the first plurality of magnets and the second plurality of magnets comprise electromagnets.

14. The catalyst feeder of claim 1, further comprising a liner disposed radially inside the housing, wherein:
the plug is disposed radially inside the liner and is rotatable relative to the liner,
the plug is sealed with the liner in the first seated position, and
the plug is unsealed from the liner in the unseated position.

15. A polymerization reaction system comprising the catalyst feeder of claim 1 coupled to a polymerization reactor and configured for feeding a solid catalyst to the polymerization reactor, the polymerization reactor comprising at least one of a slurry reactor, a gas phase reactor, or combinations thereof.

16. The polymerization reaction system of claim 15, wherein the polymerization reactor comprises at least one of a loop reactor or a stirred-tank reactor.

17. A catalyst feeder for a solid catalyst, the catalyst feeder comprising:
a housing;
a plug disposed radially inside the housing and rotatable relative to the housing, the plug having a first magnet coupled to an axial end of the plug, the first magnet radially centered on the axial end; and
an end plate coupled to the housing, the end plate having a second magnet coupled to a surface of the end plate facing towards the axial end of the plug, the second magnet axially aligned with the first magnet, thereby applying a magnetic force continuously on the plug in a first axial direction towards a seated position in relation to the housing.

18. The catalyst feeder of claim 17, wherein:
the housing comprises a catalyst inlet, a flush inlet, and a catalyst outlet,
the plug comprises first and second ports offset from each other in a circumferential direction,
when the plug is in a first rotational position, the plug is in a first seated position in relation to the housing, the first port is aligned with the catalyst inlet, and the second port is aligned with each of the flush inlet and the catalyst outlet,
when the plug is in a second rotational position, the plug is in an unseated position in relation to the housing; and
when the plug is in a third rotational position, the plug is in a second seated position in relation to the housing, the first port is aligned with each of the flush inlet and the catalyst outlet, and the second port is aligned with the catalyst inlet;
wherein the second rotational position is between the first and third rotational positions.

19. The catalyst feeder of claim 17, wherein the first and second magnets comprise neodymium.

20. A polymerization reactor comprising the catalyst feeder of claim 17, the catalyst feeder coupled to the polymerization reactor for feeding a solid catalyst to the polymerization reactor, the polymerization reactor comprising at least one of a slurry reactor, a gas phase reactor, or combinations thereof.

21. A process of using a catalyst feeder for forming a polymer, comprising:
positioning a plug in a first rotational position relative to a housing of the catalyst feeder, the catalyst feeder further comprising:
an end plate coupled to the housing;
when the plug is in the first rotational position, providing a first batch of solid catalyst to a first port of the plug;
rotating the plug to a further rotational position relative to the housing;
when the plug is in the further rotational position, providing a fluid to the first port of the plug to flush the first batch of solid catalyst into a reactor coupled to the housing; and
when the plug is in the further rotational position, providing a second batch of solid catalyst to a second port of the plug, the second port offset in a circumferential direction from the first port; wherein:
when the plug is in each of the first and further rotational positions, one or more magnets coupled to an axial end of the plug are axially aligned with one or more magnets coupled to a surface of the end plate facing the axial end of the plug to apply a first magnetic force on the plug in a first axial direction towards a first seated position in relation to the housing.

22. The process of claim 21, wherein when the plug is in an intermediate rotational position between the first and further rotational positions, the one or more magnets coupled to the plug are axially offset from each of the one or more magnets coupled to the end plate, thereby applying a second magnetic force on the plug in a second axial direction towards an unseated position in relation to the housing.

23. The process of claim 21, wherein the reactor comprises at least one of a slurry reactor, a gas phase reactor, or combinations thereof.

24. The process of claim 21, wherein the fluid comprises an alkane having from 2 to 10 carbon atoms.

25. The process of claim 24, wherein the fluid comprises isobutane.
